(19) United States
(12) Patent Application Publication
(10) Pub. No.: US 2012/0165988 A1
(43) Pub. Date: Jun. 28, 2012

(54) METHOD AND APPARATUS FOR COLLECTING BUILDING MANAGEMENT DATA

(75) Inventors: Chang-Sic CHOI, Daejeon (KR); Wan Ki PARK, Daejeon (KR); Jinsoo HAN, Daejeon (KR); Youn Kwae JEONG, Daejeon (KR); IL Woo LEE, Daejeon (KR)

(73) Assignee: ELECTRONICS AND TELECOMMUNICATIONS RESEARCH INSTITUTE, Daejeon (KR)

(21) Appl. No.: 13/325,524

(22) Filed: Dec. 14, 2011

(30) Foreign Application Priority Data
Dec. 22, 2010 (KR) 10-2010-0132060

(51) Int. Cl. G05B 15/00

(52) U.S. Cl. 700/275

(57) ABSTRACT

An apparatus collecting building management data, the apparatus includes a plurality of central control & monitoring systems (CCMSs) for receiving building management data collected from various facilities and sensors installed in the building; an object filter for filtering the building management data to produce filtered building management data; and a common communication layer (CCL) message generator for converting the filtered building management data into common building management data. The converted common building management data is used for constructing common management environment of individual buildings.

### CROSS-REFERENCE TO RELATED APPLICATION(S)

The present invention claims priority of Korean Patent Application Nos. 10-2010-0132060, filed on Dec. 22, 2010, which is incorporated herein by reference.

### FIELD OF THE INVENTION

The present invention relates to building management and operation technology, and more particularly, to an apparatus and method for collecting building management data generated from individual buildings, and converting the collected building management data into the format of common data.

### BACKGROUND OF THE INVENTION

Recently, with the climate change convention, a variety of low-carbon based energy reduction policies have been promoted by various countries, and a variety of energy reduction technologies have been researched in a field of building management which takes a large part in energy consumption. The research on technologies for energy reduction of buildings is developed toward passive reduction technology and active reduction technology. The passive reduction technology is aimed at environment-friendly and high-efficiency structures and materials of buildings, and the active reduction technology is focused on replacement of low-power facility in buildings and optimal management of the buildings.

Particularly, in the active energy reduction technology for buildings, research is being actively conducted on building automation which is focused on the existing functions of the buildings. Furthermore, research is being also actively conducted on a building energy management system (BEMS) technology for managing a building in point of energy, escaping from the existing building management technology. However, the technologies of the BEMS require getting an expert consulting for analyzing individual buildings and developing an optimal building management, which entails a lot of cost and time. Moreover, it is difficult to draw voluntary participations from building owners.

In order to overcome such problems, research is being conducted on an integrated management system for buildings based on a remote control system by a small number of BEMS management experts. However, when integrated control systems are constructed, there are many difficulties in constructing and managing the integrated control systems because of the different building management environments such as individual control networks and non-compatibility between the systems due to different manufacturers.

In order to introduce the optimal management system for energy reduction into a large number of buildings, it is necessarily needed the development of a remote control ystem based on low cost and high efficiency. Through the remote control system, an optimal management plan for integrally managing various buildings and reducing energy may be derived.

However, it is difficult to integrally and consistently analyze building management data and derive an optimal management plan for individual buildings which are managed under a variety of building management environments such as heterogeneous building automation systems (BAS) and building energy management systems (BEMS). Furthermore, since separate analysis and derivation for each building are required, the efficiency of the remote control system decreases, and the management cost inevitably increases.

### SUMMARY OF THE INVENTION

In view of the above, the present invention provides an apparatus and method for collecting data generated from individual buildings managed by heterogeneous BASs/BEMSs and converting the collected data into the format of common data suitable for a remote building control system.

In accordance with a first aspect of the present invention, there is provided an apparatus collecting building management data, the apparatus including:

a plurality of central control & monitoring systems (CCMSs) for receiving building management data collected from various facilities and sensors installed in the building;

an object filter for filtering the building management data to produce filtered building management data; and

a common communication layer (CCL) message generator for converting the filtered building management data into common building management data,

wherein the converted common building management data is used for constructing a common management environment of individual buildings.

Further, the object filter selectively sorts out the building management data by referring to a monitoring reference table which is constructed in such a manner as to select the collected building management data.

Further, the building management data collected from the CCMSs has a combined form of data and an object generating the data.

Further, the building management data includes BAS (Building Automation System) management data and sensing data; the BAS management data includes data generated from one or more of an air conditioning facility, a power facility, an illumination facility, and a security facility; and the sensing data includes data on temperature, humidity, CO₂, and power and gas consumption of the building, that are detected by sensors.

Further, the common building management data is a CCL message based on a CCL.

Further, the CCL message includes the collected building management data, the monitoring reference table, and monitoring time.

Further, the CCL message includes one or more of a building ID, a facility type, a facility control protocol, an object, positional information of the object, a collection time, and a sensing value and a state value of the object.

In accordance with a second aspect of the present invention, there is provided a method for collecting building management data in a remote building control system for respective buildings, the remote building control system including data collection clients installed in the respective buildings and a remote control server, the method including:

searching, at the remote control server, one or more candidate data collection clients to be subjected to a building management;

transmitting, at the candidate data collection clients, client response messages to the building control server;

transmitting, at the remote control server, a building management data request message to the candidate data collection clients; and

providing, at the candidate data collection clients, building management data collected from the respective buildings to the remote control server.

Further, said providing building management data includes:

filtering the building management data;

converting the filtered building management data into a form of common building management data for constructing a common management environment of the individual buildings; and

transmitting the converted building management data to the remote control server.

Further, said filtering the building management data includes:

receiving a monitoring reference table from the remote control server, the monitoring reference table being constructed in such a manner as to select the collected building management data; and

sorting out the building management data by referring to the monitoring reference table.

Further, the building management data has a combined form of data value and an object generating the building management data.

Further, the building management data comprises BAS management data and sensing data; the BAS management data comprises data generated from one or more of an air conditioning facility, a power facility, an illumination facility, and a security facility; and the sensing data comprises data on temperature, humidity, CO₂, and power and gas consumption of the building, that are detected by sensors.

Further, the common building management data is a CCL message based on a common communication layer (CCL).

Further, the CCL message comprises the collected building management data, the monitoring reference table, and monitoring time.

Further, the CCL message comprises one or more of a building ID, a facility type, a facility control protocol, an object, positional information of an object, an information collection time, and sensing value and a state value of the object.

### BRIEF DESCRIPTION OF THE DRAWINGS

The above and other objects and features of the present invention will become apparent from the following description of embodiments given in conjunction with the accompanying drawings, in which:

FIG. 1 is a schematic block diagram of a remote building control system in accordance with an embodiment of the present invention;

FIG. 2 illustrates an operation of a data collection client shown in FIG. 1;

FIG. 3 illustrates an operation of a common communication layer (CCL) message generator in the data collection client shown in FIG. 1; and

FIG. 4 is a flow chart illustrating a method performed in a remote building control system in accordance with the embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

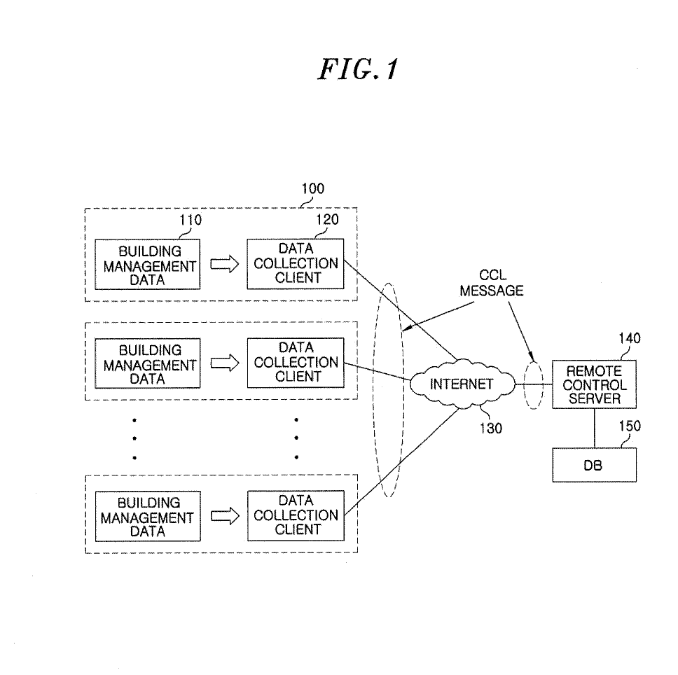

FIG. 1 is a block diagram of a remote building control system in accordance with an embodiment of the present invention.

Referring to FIG. 1, the remote building control system includes a plurality of data collection clients 120 and a remote control server 140. The data collection clients 120 are installed in individual buildings 100 and configured to collect building management data generated from the individual buildings 100, respectively. The data collection clients 120 and the remote control server 140 may be implemented as a client-server environment with a network 130 such as the wired/wireless Internet.

Specifically, each of the data collection clients 120 is installed in a corresponding building 100 to be subjected to a building management, and collects building management data 110 generated from the corresponding building.

The building management data 110 may include BAS management data of the building 100 and a variety of sensing data on temperature, humidity, CO₂, power consumption, and gas consumption. The building management data 110 collected by the data collection client 120 are transmitted to the remote control server 140 through the network.

The remote control server 140 receives and stores the information collection client 110 from the respective data collection clients 120 in a database (DB) 150.

Alternatively, the information collection client 110 from the respective data collection clients 120 may be provided to a server for security and/or management measure establishment.

Before transmitting the information collection client 110 from the respective data collection clients 120, the data collection clients 120 convert the information collection client 110 into the form of common building data for constructing a common management environment of the buildings to generate a common communication layer (CCL) message to be transmitted to the remote control server 140. Through this operation, the remote control server 140 may standardize the management methods of the respective buildings while guaranteeing compatibility the building management data generated from the respective buildings, and consistently process the building management data.

Alternatively, the data collection client 120 may be configured to generate a CCCL message by a separate CCCL message generator.

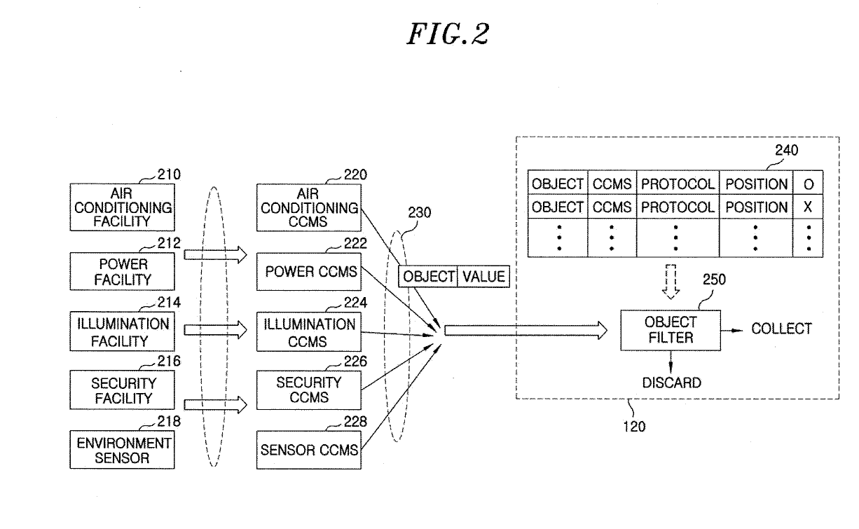

FIG. 2 illustrates the operation in which a data collection client shown in FIG. 1 collects generated from the building management data.

Referring to FIG. 2, the data collection client 120 includes a variety of central control & monitoring systems (CCMS) 220, 222, 224, 226, and 228 for separate facilities and sensors in the building 100. The CCMSs 220 to 228 collect the BAS management data generated from BAS facilities 210, 212, 214, and 216 and the sensing data sensed by environment sensors 218. The CCMSs 220 to 228 include an air conditioning CCMS 220, a power CCMS 222, an illumination CCMS 224, a security CCMS 226, and a sensor CCMS 228. The air conditioning CCMS 220 receives information generated from an air conditioning facility 210. The power CCMS 222 receives information generated from a power facility 212. The illumination CCMS 224 receives information generated from an illumination facility 214. The security CCMS 226 receives information generated from a security facility 216. The sensor CCMS 228 receives sensing data sensed by various environment sensors 218.

As illustrated in FIG. 2, the CCMSs 220 to 228 may be separately provided or integrated in one CCMS.

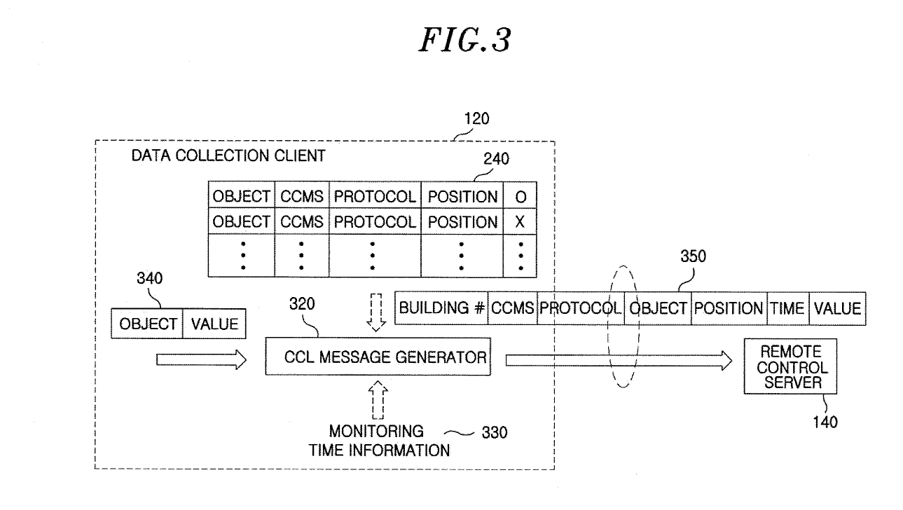

The communication between the various facilities and sensors 210 to 218 and the CCMSs 220 to 228 may be performed through a control and communication protocol such as BACnet, MODbus, LonWorks, TCP/IP, Zigbee, Serial COM, Bluetooth, or UWB, but is not limited thereto. Furthermore, as will be described with reference to FIG. 3, the respective CCMSs 220 to 228 converts the building management data 110 to a CCL message 230 with a combined form of data and an object generating the data through the use of a CCL message generator 230, which will then be transmitted to the remote control server 140.

The data collection client 120 further includes an object filter 250. The object filter 250 sorts out the building management data which are to be transmitted to the remote control server 140, based on a monitoring reference table 240 provided from the remote control server 140. More specifically, the object filter 250 collects necessary building management data and discards unnecessary building management data by referring to the monitoring reference table 240. The necessary building management data includes building management data generated from a facility indicated by ‘O’ in the monitoring reference table 240 or building management data collected by a CCMS corresponding to the facility, and the unnecessary building management data includes building management data generated from a facility indicated by ‘X’ in the monitoring reference table 240.

FIG. 3 illustrates the operation of the CCL message generator in the data collection client 110 shown in FIG. 1.

Referring to FIG. 3, the data collection client 120 further includes a CCL message generator 320 configured to convert building management data 340 having passed through the object filter 250 into a CCL message 350. The CCL message has a structure which may be effectively utilized for monitoring and analyzing the building management data 340 by defining it in a common message type.

The CCL message generator 320 collects the building management data 340, monitoring time 330, and the data of the monitoring reference table 240, and converts the collected data into the CCL message 350 such that the remote control server 140 facilitates the storage and analysis of the building management data. For example, the BAS building management data 340 represented in the form of <object, value> is converted into the form of <building #, CCMS, protocol, object, position, time, value> including the meanings of <building ID, facility type, facility control protocol, object, positional information of object, information collection time, and sensing value or state value of object>.

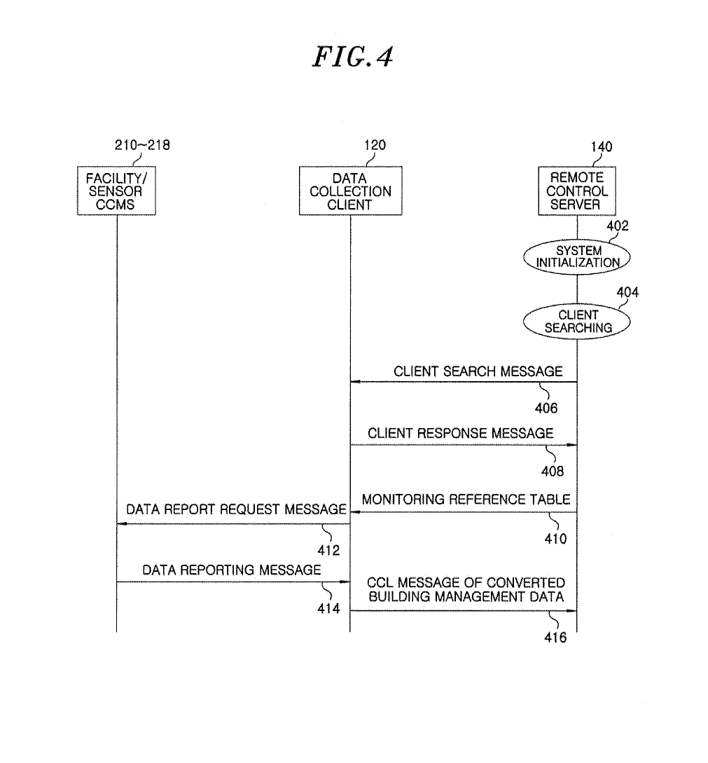

FIG. 4 is a flow chart illustrating a method performed by a remote building control system in accordance with the embodiment of the present invention.

Referring to FIG. 4, the remote control server 140 performs initialization of the remote building control system at step S402, and performs a client searching to initialize building management data collected from one or more buildings to be subjected to a building management and the data collection clients of the buildings at step S404.

At step S406, the remote control server 140 broadcasts a client search message to the data collection client 120 for each of the buildings. At step S408, in response to the client search message, the data collection client 120 unicasts a client response message, for example, a keep alive message to the remote control server 140, in order to inform the remote control server 140 that preparation was completed. The client search message is broadcast to the data collection clients 120 from the remote control server 140, while the client response messages of the data collection clients 120 are unicast to the remote control server 140.

Thereafter, at step S410, the remote control server 140 transmits in a broadcast mode a monitoring reference table 240 to the data collection clients 120 which are recognized to be in the preparation state.

At step S412, the data collection client 120 transmits in a unicast mode a message requesting a report of building management data to the CCMSs 220 to 228. At step S414, the respective CCMSs 220 to 228 send in a broadcast mode a data reporting message containing the building management data to the data collection client 120.

After that, the data collection client 120 receives the data reporting message from the CCMSs 220 to 228, and filters the building management data through the object filter 250. At step S416, the building management data 340 filtered by the data collection client 120 is converted into a CCL message representative of building management data before transmitting to the remote control server 140.

Therefore, the remote control server 140 may construct a common management environment, and standardize the management method for buildings.

In accordance with the embodiment of the present invention, individual buildings based on the existing BAS/BEMS may interwork with the remote control system only by connecting the data collection clients, while maintaining the management environments of the buildings.

Furthermore, it is possible to provide an efficient collection for building management data through the filtering using the monitoring reference table for mass transmission of the building management data and effective data analysis.

While the invention has been shown and described with respect to the preferred embodiments, it will be understood by those skilled in the art that various changes and modifications may be made without departing from the scope of the invention as defined in the following claims.

What is claimed is:

1. An apparatus collecting building management data, the apparatus comprising:
a plurality of central control & monitoring systems (CCMSs) for receiving building management data collected from various facilities and sensors installed in the building;
an object filter for filtering the building management data to produce filtered building management data; and
a common communication layer (CCL) message generator for converting the filtered building management data into common building management data,
wherein the converted common building management data is used for constructing a common management environment of individual buildings.

2. The apparatus of claim 1, wherein the object filter selectively sorts out the building management data by referring to a monitoring reference table which is constructed in such a manner as to select the collected building management data.

3. The apparatus of claim 1, wherein the building management data collected from the CCMSs has a combined form of data and an object generating the data.

4. The apparatus of claim 1, wherein the building management data comprises BAS (Building Automation System) management data and sensing data,
wherein the BAS management data comprises data generated from one or more of an air conditioning facility, a power facility, an illumination facility, and a security facility, and
the sensing data comprises data on temperature, humidity, CO₂, and power and gas consumption of the building, that are detected by sensors.

5. The apparatus of claim 1, wherein the common building management data is a CCL message based on a CCL.

6. The apparatus of claim 5, wherein the CCL message comprises the collected building management data, the monitoring reference table, and monitoring time.

7. The apparatus of claim 6, wherein the CCL message comprises one or more of a building ID, a facility type, a facility control protocol, an object, positional information of the object, a collection time, and a sensing value and a state value of the object.

8. A method for collecting building management data in a remote building control system for respective buildings, the remote building control system including data collection clients installed in the respective buildings and a remote control server, the method comprising:
searching, at the remote control server, one or more candidate data collection clients to be subjected to a building management;
transmitting, at the candidate data collection clients, client response messages to the building control server;
transmitting, at the remote control server, a building management data request message to the candidate data collection clients; and
providing, at the candidate data collection clients, building management data collected from the respective buildings to the remote control server.

9. The method of claim 8, wherein said providing building management data comprises:
filtering the building management data;
converting the filtered building management data into a form of common building management data for constructing a common management environment of the individual buildings; and
transmitting the converted building management data to the remote control server.

10. The method of claim 9, wherein said filtering the building management data comprises:
receiving a monitoring reference table from the remote control server, the monitoring reference table being constructed in such a manner as to select the collected building management data; and
sorting out the building management data by referring to the monitoring reference table.

11. The method of claim 8, wherein the building management data has a combined form of data value and an object generating the building management data.

12. The method of claim 11, wherein the building management data comprises BAS management data and sensing data,
wherein the BAS management data comprises data generated from one or more of an air conditioning facility, a power facility, an illumination facility, and a security facility; and the sensing data comprises data on temperature, humidity, CO₂, and power and gas consumption of the building, that are detected by sensors.

13. The method of claim 8, wherein the common building management data is a CCL message based on a common communication layer (CCL).

14. The method of claim 13, wherein the CCL message comprises the collected building management data, the monitoring reference table, and monitoring time.

15. The method of claim 14, wherein the CCL message comprises one or more of a building ID, a facility type, a facility control protocol, an object, positional information of an object, an information collection time, and sensing value and a state value of the object.
